(19) United States
(12) Patent Application Publication
(10) Pub. No.: US 2006/0221873 A1
(43) Pub. Date: Oct. 5, 2006

(54) System and method for wireless multiple access

(76) Inventor: Jacob Sharony, Dix Hills, NY (US)

Correspondence Address: INGRASSIA FISHER & LORENZ, P.C., 7150 E. CAMELBACK, STE. 325, SCOTTSDALE, AZ, 85251, US

(21) Appl. No.: 11/095,820

(22) Filed: Mar. 31, 2005

(51) Int. Cl. H04B 7/005; H04Q 7/00

(52) U.S. Cl. 370/278; 370/329

(57) ABSTRACT

Described is a system which includes an access point and a plurality of wireless devices. The access point transmits a predetermined number of first signals using a first wireless communication mode (“FCM”). The predetermined number of the first signals corresponds to a number of transmitting antennas of the access point. The FCM provides a time slot for each of the first signals to be transmitted. Each of the wireless devices receives each of the first signals. Each wireless device utilizes the first signals to generate a first communication matrix. Each of the wireless devices transmits a second signal to the access point. The access point generates a second communication matrix as a function of the second signals corresponding to a number of selected wireless devices. The number of selected wireless devices is no greater than the predetermined number of first signals. The access point initiates wireless communications with at least one of the selected wireless devices using a second wireless communication mode (“SCM”). When using the SCM, the access point employs the second communication matrix to resolve multiple wireless communications from the selected wireless devices and each of the selected wireless devices employs the corresponding first communication matrix to resolve multiple wireless communications from the access point during a single time slot over a radio channel.

### CROSS-REFERENCE TO RELATED APPLICATIONS

The present application relates to and incorporates by reference the entire disclosures of U.S. Application entitled “Access Point and Method for Wireless Multiple Access” filed on Mar. 31, 2005 naming Jacob Sharony as inventor, and U.S. Application entitled “Wireless Device and Method for Wireless Multiple Access” filed on Mar. 31, 2005 naming Jacob Sharony as inventor.

### BACKGROUND

A wireless local area network (WLAN) is a flexible data communications system which may either replace or extend a conventional, wired LAN. The WLAN may provide added functionality and mobility over a distributed environment. That is, the wired LAN transmits data from a first computing device to a further computing device across cables or wires which provide a link to the LAN and any devices connected thereto. The WLAN, however, relies upon radio waves to transfer data between wireless devices. Data is superimposed onto the radio wave through a process called modulation, whereby a carrier wave acts as a transmission medium.

Exchange of data between the wireless devices over the WLAN has been defined and regulated by standards ratified by the Institute of Electrical and Electronics Engineering (IEEE). These standards include a communication protocol generally known as 802.11, and having several versions, including 802.11a, 802.11b (“Wi-Fi”), 802.11e, 802.11g and 802.11n. Recently, there has been a surge in deployment of 802.11-based wireless infrastructure networks to provide WLAN data sharing and wireless internet access services in public places (e.g., “hot spots”).

Conventional WLANs utilize a single-in-single-out (“SISO”) cellular sharing architecture, in which data is transferred over a radio channel in a cell. Because the channel is shared by all wireless devices (e.g., mobile units and an access point) within the cell, each device must contend for access to the channel, thus, allowing only one device to transmit on the channel at a given time. Consequently, conventional WLANs present a number of limitations (e.g., delayed transmission times, failed transmission, increased network overhead, limited scalability, etc.).

In an effort to overcome the limitations of the conventional WLAN, a multiple-in-multiple-out (“MIMO”) shared WLAN architecture has been developed. A MIMO mode uses spatial multiplexing to increase a bit rate and accuracy of data sent between the wireless devices. In the MIMO mode, a single high-speed data stream (e.g., 200 mbps) is divided into several low-speed data streams (e.g., 50 mbps), transmitted to the wireless device (e.g., mobile unit) and recombined into the high-speed data stream for resolving the transmission. However, this high-speed connection is provided only for one-to-one communication (e.g., access point to a single mobile unit) at a given time. In addition, wireless devices operating according to a first version of the 802.11 protocol (e.g., 802.11a, 802.11b, 802.11g, etc.) may not support the high-speed connection without a hardware and/or a software modification(s), which may represent significant costs to operators of the WLAN.

### SUMMARY OF THE INVENTION

The present invention relates to a system which includes an access point and a plurality of wireless devices. The access point transmits a predetermined number of first signals using a first wireless communication mode (“FCM”). The predetermined number of the first signals corresponds to a number of transmitting antennas of the access point. The FCM provides a time slot for each of the first signals to be transmitted. Each of the wireless devices receives each of the first signals. Each wireless device utilizes the first signals to generate a first communication matrix. Each of the wireless devices transmits a second signal to the access point. The access point generates a second communication matrix as a function of the second signals corresponding to a number of selected wireless devices. The number of selected wireless devices is no greater than the predetermined number of first signals. The access point initiates wireless communications with at least one of the selected wireless devices using a second wireless communication mode (“SCM”). When using the SCM, the access point employs the second communication matrix to resolve multiple wireless communications from the selected wireless devices and each of the selected wireless devices employs the corresponding first communication matrix to resolve multiple wireless communications from the access point during a single time slot over a radio channel.

### BRIEF DESCRIPTION OF THE DRAWINGS

FIG. 1 shows an exemplary embodiment of a system according to the present invention.

FIG. 2 shows an exemplary embodiment of a downstream protocol according to the present invention.

FIG. 3 shows an exemplary embodiment of an upstream protocol according to the present invention.

FIG. 4 shows an exemplary embodiment of a method according to the present invention.

FIG. 5 shows a schematic view of an exemplary embodiment of wireless communication of the system according to the present invention.

FIG. 6 shows an exemplary embodiment of a relationship between an aggregate system throughput and a number of antennas of the system according to the present invention.

FIG. 7 shows a further exemplary embodiment of the relationship between the aggregate system throughput and the number of antennas of the system according to the present invention.

### DETAILED DESCRIPTION

The present invention may be further understood with reference to the following description and the appended drawings, wherein like elements are referred to with the same reference numerals. The exemplary embodiment of the present invention describes a protocol for providing multiple access to a wireless environment for wireless devices therein. In addition, the protocol of the present invention is preferably compatible with legacy 802.11-based wireless devices using conventional access mechanisms.

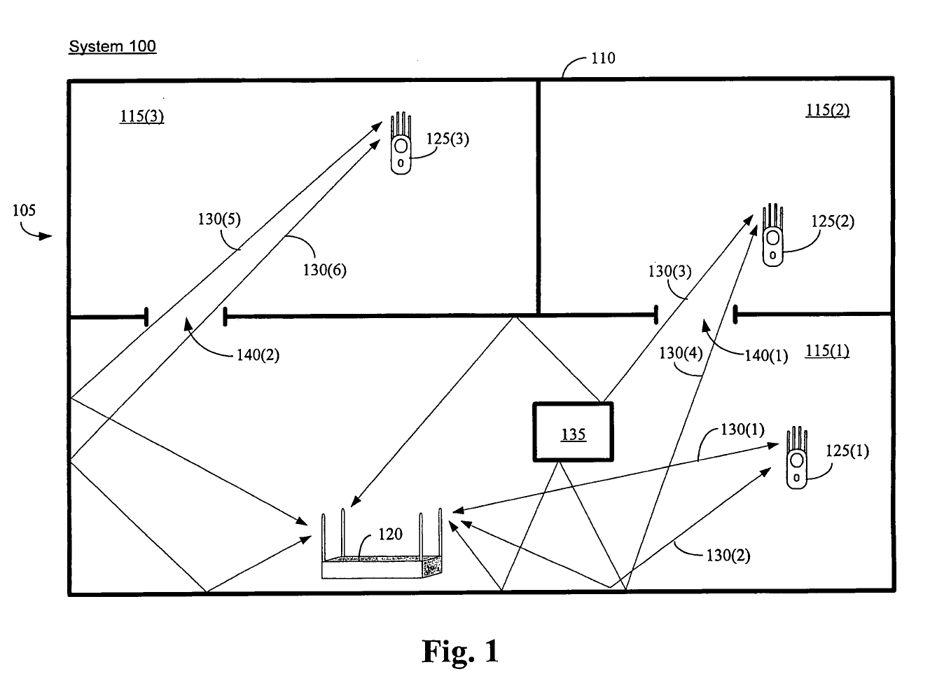

FIG. 1 shows a system 100 according to the present invention. The system 100 may include a WLAN 105 deployed within a space 110. As understood by those skilled in the art, the space 110 may be either an enclosed environment (e.g., a warehouse, office, home, store, etc.), an open-air environment (e.g., park, etc.) or a combination thereof. The space 110 may be one area or partitioned into more than one area (e.g., an area 115). The areas 115 are limited neither in number or dimension. As shown in FIG. 1, the space 110 is divided into the areas 115(1-3).

The WLAN 105 may include wireless communication devices, such as, an access point (“AP”) 120 and one or more wireless devices (e.g., mobile units (“MUs”) 125) wirelessly communicating therewith. The AP 120 may be connected to a server via the WLAN 105. Though, FIG. 1 only shows MUs 125(1-3) within the WLAN 105, those of skill in the art would understand that the WLAN 105 may include any number and type of MUs (e.g., PDAs, cell phones, scanners, laptops, handheld computers, etc.). Those of skill in the art would further understand that the MU may include a non-mobile unit attached to a wireless device (e.g., a PC with a network interface card).

Radio frequency (“RF”) signals including data packets may be transmitted between the MUs 125(1-3) and the AP 120 over a radio channel. As understood by those skilled in the art, the data packets may be transmitted using a modulated RF signal having a common frequency (e.g., 2.4 GHz, 5 GHz). Furthermore, the data packets may include conventional 802.11 packets, such as, authentication, control and data packets. The data packets travel between the AP 120 and the MUs 125(1-3) along a plurality of paths 130(1-6) within the space 110. Though, FIG. 1 only shows six paths 130(1-6), those of skill in the art would understand that a number of potential paths is essentially infinite.

Spatial configuration (e.g., length, direction, etc.) of the paths 130(1-6) may depend upon one or more factors. These factors include, but are not limited to, a location(s) of the AP 120 and/or the MUs 125(1-3), a configuration of the space 110 and/or the areas 115(1-3), a location and/or a shape of an obstruction(s) 135 therein. For example, the path 130(1) may pass substantially directly from the MU 125(1) to the AP 120, whereas the path 130(2) may reflect from a structure (e.g., a wall). The paths 130(3-4) between the MU 125(2) and the AP 120 may pass from the area 115(2) to the area 115(1) via an opening (e.g., a doorway 140(1), a window, etc.), and may then reflect from one or more structures (e.g., wall(s), obstruction 135, etc.) in area 115(1). The paths 130(5-6) between the MU 125(3) and the AP 120 may pass from the area 115(3) to the area 115(1) via an opening (e.g., a doorway 140(2), a window), and may then reflect from one or more structures (e.g., obstruction 135, wall(s), etc.). Although, not shown in FIG. 1, those of skill in the art would understand that the paths 130(1-6) may have varied spatial configurations and pass through any of the structures and/or obstructions described.

The data packets which are transmitted by the MUs 125(1-3) and/or the AP 120 may differ from the data packets which are received. That is, changes in a length and/or a number of reflections of each of the paths 130(1-6) may result in variations in attributes of the RF signal, such as, amplitude, phase, arrival time, frequency distribution, etc. Reflective properties of the structures and/or obstructions may further influence the attributes of the signal and the data contained therein. The changes mentioned above are generally referred to as “multi-path fading.”

According to the present invention, the AP 120 and the MUs 125(1-3) may utilize a first mode of communication (e.g., 802.11a, 802.11b, 802.11g) and a second mode of communication (e.g., MIMO, 802.11n). To utilize the MIMO mode, the AP 120 may have an architecture including a processor, two or more antennas, two or more receivers and two or more transmitters. Accordingly, each antenna is capable of transmitting and receiving one or more independent signals concurrently and at a substantially common frequency (e.g., the radio channel). The processor of the AP 120 may resolve the wireless communication of the signals received from the MUs 125(1-3) or further APs.

Each MU 125 may utilize the MIMO mode using an architecture including a processor, two or more antennas, two or more receivers and one or more transmitters. The antennas and the receivers allow the MU 125 to receive one or more independent signals concurrently and at a substantially common frequency. The transmitter allows the MU 125 to transmit one or more signals to the AP 120. The processor of the MU 125 may resolve the wireless communication of the received signals from the AP 120 and/or further MUs.

In a preferred embodiment, the AP 120 includes four antennas, four receivers and four transmitters, and each MU 125 includes four antennas, four receivers and one transmitter. However, those of skill in the art would understand that the AP 120 may include any number of antennas, receivers and transmitters, but, that the number is changed in a 1:1:1 ratio. That is, for any additional antenna, an additional receiver and an additional transmitter may be included. Similarly, the MU 125 may include any number of antennas and receivers, and any change in the number is done according to a 1:1 ratio. The MU 125 may further include any number of transmitters, which would change the ratio of antennas to receivers to transmitters to 1:1:1. However, in a preferred embodiment of the present invention, the MU 125 maintains a single transmitter. In this manner, the protocol described herein may be utilized by wireless devices employing a legacy-802.11 standard (e.g., 802.11a, 802.11b, 802.11g) without significant hardware and/or software modifications. Architectures of the AP 120 and the MU 125 are described in further detail in U.S. patent application Ser. No. 10/738,167, filed on Dec. 17, 2003, entitled “A Spatial Wireless Local Area Network,” the disclosures of which are incorporated herein by reference.

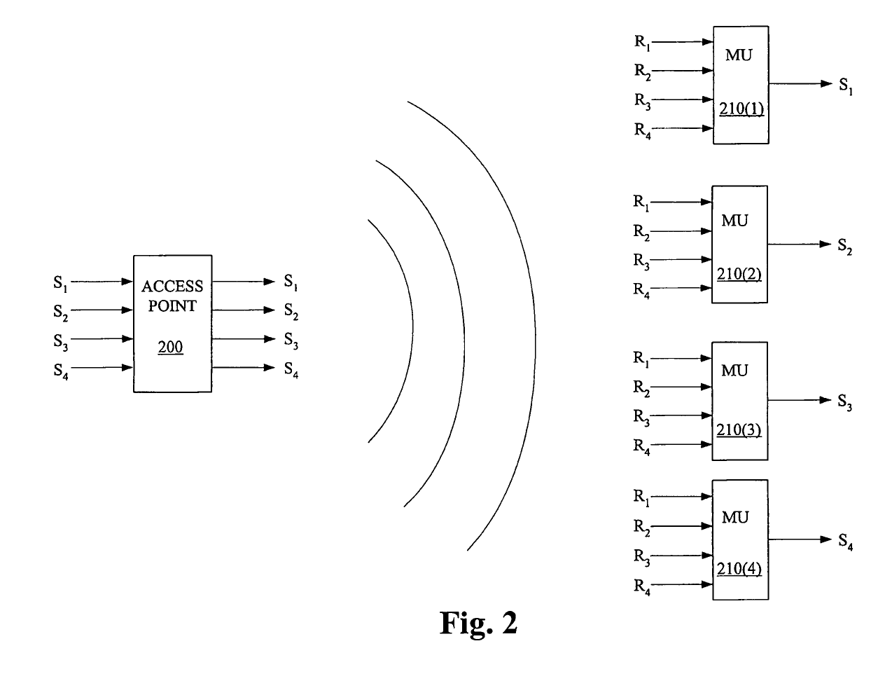

FIG. 2 shows an exemplary embodiment of wireless communication from the AP 200 to the MUs 210(1-4), which is typically referred to as “downstream” communication. In this embodiment, the AP 200 may transmit two or more signals from its two or more antennas. As shown in FIG. 2, the AP 200 has four antennas, and, correspondingly, transmits four independent signals S₁-S₄. The number of signals sent may be directly proportional to the number of antennas (e.g., one independent signal per antenna). Also, in MIMO mode, the AP 200 may transmit the signals S₁-S₄ concurrently over the radio channel, which will be described in further detail below.

Due to the multi-path fading and any other factors contributing to signal corruption or degradation, the antennas of each MU 210 receive a signal R₁-R₄ which differs from the transmitted signals S₁-S₄. Those of skill in the art would understand that any or all of the received signals R₁-R₄ may not differ from the transmitted signals S₁-S₄. Accordingly, one or more the received signals R₁-R₄ may equal one or more of the transmitted signals S₁-S₄ (e.g., R₁=S₁) . In either instance, the received signals R₁-R₄ may be related to the transmitted signals S₁-S₄ by a signal-relation equation: R₁=ΣaᵢⱼSⱼ+nᵢ, where aᵢⱼ are elements of a transmission matrix and nᵢ represents a noise level on a receiving channel i.

Each MU 210 estimates the transmission matrix aᵢⱼ using at least a portion of the received signals R₁-R₄. In one embodiment, each of the transmitted signals S₁-S₄ includes a training packet Tⱼ, indicative of a transmission channel j used by the AP 200. The training packet Tⱼ may include a pilot sequence pⱼ which may be transmitted as a portion of a preamble signal to the transmitted signals S₁-S₄. For example, the AP 200 may send one or more training packets Tⱼ in one of a sequence of time slots. Each MU 210 may identify the pilot sequence pⱼ in each training packet and estimate the transmission matrix aᵢⱼ using a matrix equation: aᵢⱼ=Rᵢ/pⱼ. Each MU 210 may then extract the transmitted signal using the signal-relation equation, above. For example, the MU 210(1) may receive signals R₁-R₄ and use pilot sequence p₁-p₄ to resolve the transmission matrix aᵢⱼ. The transmission matrix aᵢⱼ may then be used in the signal-relation equation to resolve the transmitted signal S₁. As would be understood by those skilled in the art, the processor of the MU 210 may resolve the transmission matrix aᵢⱼ and the transmitted signal S₁ using a software application.

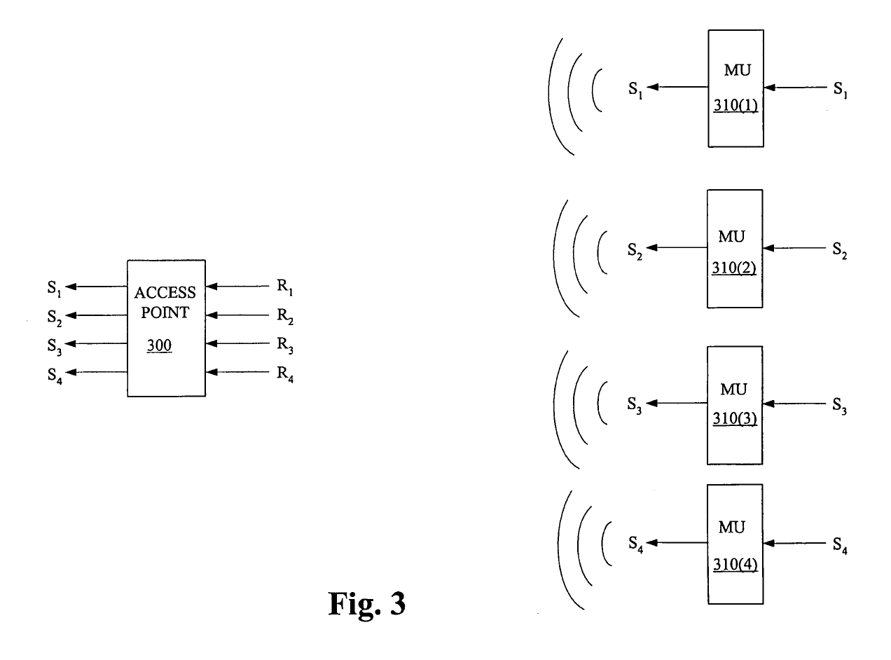

FIG. 3 shows an exemplary embodiment of communication from the MUs 310(1-4) to the AP 300, which is typically referred to as “upstream” communication. As described above, in a preferred embodiment, each MU 310 has one or more transmitters. Thus, each MU 310(1-4) transmits a signal S₁-S₄, respectively, to the AP 300. Signals R₁-R₄ received by the AP 300 may differ from the transmitted signals S₁-S₄ due to, for example, multi-path fading. The received signals R₁-R₄ are used by the AP 300 in the signal-relation equation: R₁=ΣaᵢⱼSⱼ+nᵢ, which may be the same as that used by the MU 210 in the downstream communication. That is, each of the received signals R₁-R₄ may include the training packet Tⱼ indicative of the transmission channel j used by the MU 310. The training packet Tⱼ may further include the pilot sequence pⱼ which may be transmitted as a portion of a preamble to the transmitted signals S₁-S₄. The AP 300 uses the received signals R₁-R₄ and the pilot sequences pⱼ to resolve the transmission matrix aᵢⱼ with the matrix equation: aᵢⱼ=Rᵢ/pⱼ. The transmitted signals S₁-S₄ are then resolved using the signal-relation equation.

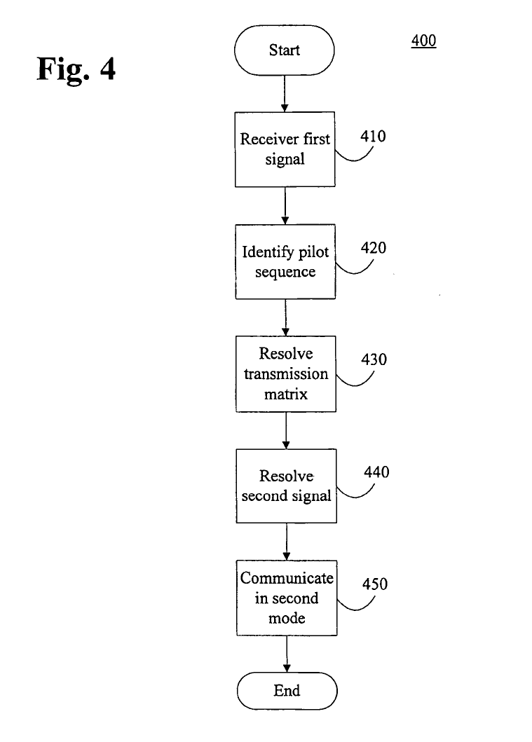

FIG. 4 shows an exemplary embodiment of a method 400 according to the present invention. In this embodiment, the method 400 is employed by a receiving station which may be any type of wireless device. For example, in the downstream communication, the MU may employ the method 400, whereas, in the upstream communication, the AP may employ the method 400. Thus, the method 400 will be described with respect to a transmitting station and the receiving station. Furthermore, according to the present invention, the receiving station and/or the transmitting station may be operating according to a first mode of communication (e.g., CSMA/CA), but also capable of operating in a second mode of communication (e.g., MIMO). Thus, the method 400 is used by the receiving station as a result of the transmitting station initiating wireless communication in the second mode of communication (e.g., MIMO mode).

In step 410, the receiving station receives at least two first signals from the transmitting station. The first signals (e.g., R₁ and R₂) are the received versions of at least two second signals (e.g., S₁ and S₂) which are transmitted by the transmitting station. As understood by those skilled in the art, the first signals may correspond to a number of transmitting antennas employed by the AP and/or the MU, or a number of MUs transmitting to the AP. The first signals may not contain any data, but may simply include the training packet Tⱼ. However, the first signal may be packets (e.g., data packets) which include the training packet Tⱼ and/or the pilot sequence pⱼ in a preamble thereof.

In step 420, the receiving station identifies the pilot sequence pⱼ included in the training packet Tⱼ. Those of skill in the art would understand that the processor in the receiving station or a software application executed thereby may extract the pilot sequence pⱼ from the training packet Tⱼ. Furthermore, the training packet Tⱼ may only include the pilot sequence pⱼ. Thus, in this embodiment, the first signals (e.g., R₁ and R₂) may simply be the pilot sequences p₁ and p₂.

In step 430, the receiving station may resolve the transmission matrix aᵢⱼ using the matrix equation. As stated above, the transmission matrix aᵢⱼ may be estimated as a function of the pilot sequence pⱼ and the first signals (e.g., R₁ and R₂). As with identification of the pilot sequence pⱼ, the processor and/or a software application executed thereby of the receiving station may utilize the matrix equation to resolve the transmission matrix aᵢⱼ.

In step 440, the receiving station may resolve the second signal using the signal-relation equation. As stated above, the second signal is estimated as a function of the transmission matrix aᵢⱼ, the first signals and the noise nᵢ on the receiving channel i. Again, the second signal may be resolved by the processor and/or a software application executed thereby of the receiving station.

In step 450, the receiving station can begin operating in the second mode of communication. Accordingly, the stations may now transmit and receive signals simultaneously over the share channel. The second mode of communication may increase overall system throughput, reduce corruption and degradation of the data, and allow operators and user of the system to maintain use of legacy 802.11 devices.

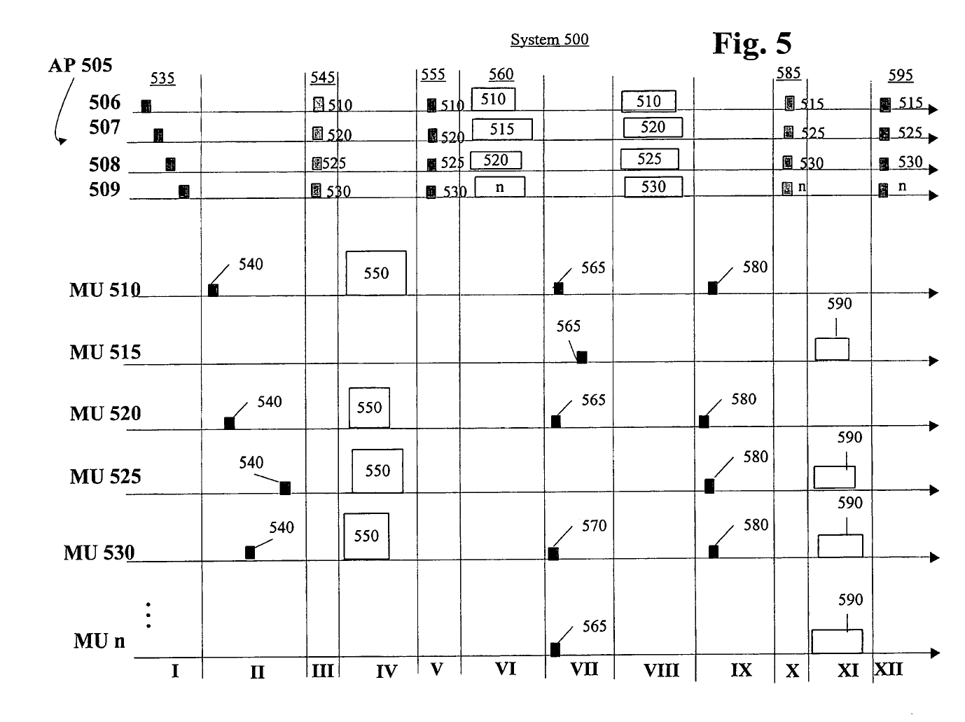

FIG. 5 shows an exemplary embodiment of a system 500 according to the present invention. The system 500 is shown as a schematic timing diagram with phases I-XII representing periods of communication over the channel. In this exemplary embodiment, an AP 505 may be equipped with four antennas 506-509, four receivers and four transmitters. Any number of MUs 510-n may be within a communication range of the AP 505. As shown in FIG. 5, each of the MUs may have one or more transmitters, along with four antennas and four receivers. As noted above, those of skill in the art would understand that there is no limitation on the number of antennas, transmitters and receivers on both the AP 505 and the MUs 510-n. However, it is preferable that the number of antennas, transmitters and receivers of the AP 505 match the number of antennas and receivers of the MUs 510-n. Furthermore, as noted above, the system 500 may be scaled based on the number of antennas on the AP 505 and/or the number of MUs within the coverage area thereof. Though, the system 500 will be described with respect to the MUs 510-n having a single transmitter, those skilled in the art would understand that more than one transmitter may be utilized by the MUs 510-n.

In FIG. 5, phases I-XII depict an exemplary embodiment of a refresh period (e.g., every 50 ms) with phase I signifying a beginning of the refresh period. Those of skill in the art would understand that the refresh period may have a duration that is inversely proportional to mobility of the MUs 510-n. For example, an increased mobility of the MUs (e.g., more likely to move in and out of the coverage area of the AP 505), may result in a shorter duration of the refresh period. Thus, at an end of the refresh period or at the beginning of a subsequent refresh period, the AP 505 may redetermine which MUs are within the coverage area thereof.

In phase I, the AP 505 transmits a training packet 535 from each antenna 506-509. As shown in FIG. 5, a total of four of the training packets 535 are transmitted in successive predetermined time slots. That is, the AP 505 accesses the channel in a conventional manner according to the first mode communication (e.g., CSMA/CA), and then transmits (e.g., broadcasts) the training packets 535 thereon. In this manner, the AP 505 may guarantee itself the ability to transmit each of the four training packets 535 successively by waiting for a short inter frame space (“SIFS”) between each transmission. As understood by those of skill in the art, the training packets 535 may be received by any MU 510-n within the coverage area of the AP 505. That is, the four training packets 535 are broadcast to all MUs within the coverage area of the AP 505.

As described above with reference to the “downstream” communication, each training packet 535 may contain the pilot sequence pⱼ. In an exemplary embodiment, each pilot sequence pⱼ contains a predetermined set of numbers which corresponds to a number and location of transmitting antennas on the AP 505. That is, in the embodiment shown in FIG. 5, each pilot sequence pⱼ may contain four numbers. Thus, receipt of the four pilot sequences pⱼ allows each MU 510-n to construct its own transmission matrix aᵢⱼ, which will be described further below. As shown in FIG. 5, each MU 510-n within the coverage area of the AP 505 may receive four pilot sequences p₁-p₄, each having the predetermined set of four numbers.

In phase II, each MU 510-n receives four of the training packets 535 from the AP 505. The MUs 510-n may then identify the pilot sequence pⱼ in each training packet 535 and use the predetermined set of numbers contained therein to resolve the transmission matrix aᵢⱼ. In the embodiment shown in FIG. 5, the transmission matrix aᵢⱼ may be a four by four matrix. This allows the MUs 510-n to estimate the channel for resolving transmissions from the AP 505. That is, the four numbers in each pilot sequence may be modified (e.g., in amplitude and/or phase) as a result of attenuation and/or multipath fading during transmission of the training packets 535. Thus, the matrix aᵢⱼ constructed by each MU 510-n may be different, and will allow each MU 510-n to resolve transmissions from the AP 505 addressed for it. As understood by those skilled in the art, every MU 510-n does not have to resolve the transmission matrix aᵢⱼ. For example, if an MU does not desire to transmit on the channel (e.g., no data packets for the AP 505), the MU may wait for the subsequent refresh period. However, in a preferred embodiment, each MU 510-n which receives the training packets 535 resolves its own transmission matrix aᵢⱼ.

After the MUs 510-n have resolved the transmission matrix aᵢⱼ, each of the MUs 510-n may decide whether it wants to communicate with the AP 505 according to the second mode of communication (e.g., MIMO mode). As shown in FIG. 5, MUs 510,520,525 and 530 desire to communicate in the MIMO mode. Thus, each of the MUs 510,520,525 and 530 transmits a control frame to the AP 505. As understood by those skilled in the art, the control frame may be a request-to-send (“RTS”) frame which is modified to indicate that each of the MUs 510,520,525 and 530 desires to communicate in the MIMO mode (e.g., MIMO RTS (“MRTS”) 540). The MRTS 540 may include a vector with a predetermined set of numbers (e.g., in FIG. 5, four numbers). Furthermore, those skilled in the art would understand that the MUs 510,520,525 and 530 transmit the MRTSs 540 to the AP. 505 by gaining access to the channel using the first mode of communication (e.g., CSMA/CA), because the AP 505 has not granted the requests to transmit in the MIMO mode. Furthermore, the AP 505, at this point, has not received any transmissions from the MUs 510-n through which it may estimate the channel (e.g., construct a transmission matrix aᵢⱼ for itself)

One or more the MUs 510-n may not desire to transmit in the MIMO mode, but simply intend to communicate according to the first mode. For example, the MU 515 does not transmit the MRTS 540 to the AP 505, because, for example, it does not have any data packets for the AP 505. Alternatively, the MU 515 may wish to wait until it has accumulated a predetermined number of data packets before transmitting in the MIMO mode.

In phase III, the AP 505 receives the MRTS 540 from the MUs 510,520,535 and 540, which is similar to the “upstream” communication described above. Although, FIG. 5 only shows that four of the MUs 510-n have requested to communicate in the MIMO mode, those of skill in the art would understand that any number of the MUs 510-n may transmit the MRTS 540 to the AP 505. For example, as shown in FIG. 5, if more than four of the MUs 510-n had requested to communicate in MIMO mode, the AP 505 may have to determine which of the MUs 510-n would be cleared to communicate in the MIMO mode. The AP 505 may invoke a priority scheme based on, for example, bandwidth required and/or application type (e.g., voice, scans, email, etc.). In this manner, the AP 505 may choose four of the MUs 510-n with the highest priority to communicate in the MIMO mode. The AP 505 may respond to any number (e.g., 2, 3 . . . n) of requests to communicate in the MIMO mode. Thus, the remaining MUs may communicate in the first mode (e.g., CSMA/CA) when the channel is free, or wait until a subsequent refresh period or MIMO phase.

Upon receipt of the MRTSs 540, the AP 505 may use the vectors contained in each to resolve its transmission matrix aᵢⱼ. That is, the AP 505 has received communications from the MUs which allow it to estimate the channel. Thus, in this embodiment, the AP 505 can now communicate with the four MUs at a first bit rate (e.g., 54 mbps). Alternatively, the AP 505 may communicate with three MUs at a second bit rate (e.g., 72 mbps). In either of these embodiments, each transmitting antenna of the AP 505 may allow for communication at a predefined bit rate. Thus, this bit rate can be varied/divided in any fashion (e.g., based on data type, application, etc.) to partition a bandwidth for the channel.

Utilizing the transmission matrix aᵢⱼ to resolve concurrent transmissions from the MUs, the AP 505 can begin to communicate in the MIMO mode. That is, the AP 505 may transmit control frames 545 concurrently and on the same frequency to each of the MUs 510,520,525 and 530. As understood by those skilled in the art, the control frame may be a clear-to-send (“CTS”) frame which is modified to indicate that each of the MUs 510,520,525 and 530 may begin communicating in the MIMO mode (e.g., MIMO CTS (“MCTS”) 545). In a further exemplary embodiment, the MCTS may be broadcast to the MUs 510-n. However, the broadcast may define which of the MUs 510-n is cleared to send in the MIMO mode.

As shown in FIG. 5, the AP 505 is responding to the MRTSs 540 from the MUs 510,520,525 and 530 to communicate in the MIMO mode. However, the AP 505 may initiate communication in the MIMO mode at the start of the refresh period. That is, the AP 505 may transmit the MCTSs 545 in the phase I to any four of the MUs 510-n. This may happen if, for example, each of the four MUs receiving the MCTSs 545 in the start of the refresh period maintained its transmission matrix aᵢⱼ. The four of the MUs 510-n may be determined by the AP 505 using, for example, the priority scheme described above. Thus, according to the present invention, one or more of the MUs 510-n or the AP 505 may initiate and/or request communication in the MIMO mode.

In phase IV, the MUs 510,520,525 and 530 have been cleared to transmit data packets 550 in the MIMO mode. Each of the MUs 510,520,525 and 530, may transmit the data packets 550 concurrently to the AP 505. Using the transmission matrix aᵢⱼ, the AP 505 can resolve the data packets, as described above with reference to the “upstream” communication.

In phase V, the AP 505, communicating in the MIMO mode, may transmit acknowledgment signals (“ACKs”) 555 concurrently to each of the MUs 510,520,525 and 530 which transmitted the data packets 550. As understood by those skilled in the art, the MUs 510,520,525 and 530 may continue transmitting data packets 550 and receiving the ACKS 555 in the MIMO mode for a predetermined amount of time and/or according to a defined protocol.

In phase VI, the AP 505 transmits data packets 560, which may have been buffered at, or presently received by, the AP 505 to the MUs 510,515,520 and n. As shown in FIG. 5, the AP 505 is transmitting the data packets 560 in the MIMO mode to the MUs 515 and n which had not requested to transmit in the MIMO mode in phase II or been cleared to transmit in the MIMO mode in phase III. However, as noted above, each MU 510-n within the coverage area of the AP 505 receives the training packets 535 and the pilot sequences pⱼ contained therein. Thus, the MUs 515 and n may resolve the signals from the AP 505 to extract the data packets 560 addressed therefor.

In phase VII, the MUs 510,515,520 and n which received the data packets 560 transmit ACKS 565 to the AP 505, confirming receipt of the data packets 560. In this embodiment, the MU 515 did not previously request to communicate in the MIMO mode in the phase II. The MU 515 may receive the data packet 560 from the AP 505 transmitting in the MIMO mode, but it may not transmit in the MIMO mode without being cleared to do so by the AP 505. Thus, as shown in FIG. 5, the MU 515 transmits the ACK 565 and an MRTS according to the first mode (e.g., CSMA/CA) requesting that it be allowed to communicate in the MIMO mode. As understood by those skilled in the art, the ACK 565 may be sent separately from the MRTS, or the MRTS may be piggybacked thereon.

Furthermore, as shown in FIG. 5, the MU 530 did not receive the data packet 560 from the AP 505 in phase VI. However, the MU 530 desires to retain the capability to communicate in the MIMO mode. Those of skill in the art would understand that the MU 530 may desire retention of MIMO-capability if, for example, the MU 530 has further data packets to transmit to the AP 505. In this case, the MU 530 transmits a control frame (e.g., MRTS 570) to the AP 505. The MU 530 may transmit the MRTS 570 in a time slot in which the MUs 510,520 and n are transmitting their respective ACKS 565, because the MU 530 had received the MCTS 545 in phase III.

In phase VIII, after receiving the ACKs 565 and/or the MRTSs 570, the AP 505 may transmit further data packets 575, which may have been buffered at, or presently received by, the AP 505. As shown in FIG. 5, the data packets 575 are transmitted to the MUs 510,520,525 and 530. As stated above, the data packets 575 are transmitted concurrently from the AP 505 in a time slot. In phase IX, the MUs 510,520,525 and 530 which received the data packets 575 concurrently transmit ACKS 580 to the AP 505, confirming receipt of the data packets 575.

In phase X, the AP 505 transmits a control frame (e.g., MCTS 585) to each of the MUs 515,525,530 and n which requested communication in the MIMO mode in phase VII. Also, the MU 525 which may not have requested communication in MIMO mode in phase VII, may have piggybacked a MRTS on the ACK 580 in phase IX. Similarly, the MU n in phase VII may have piggybacked an MRTS on the ACK 565. Thus, the MUs 515,525,530 and n are cleared to communicated in the MIMO mode by the AP 505. In phase XI, the MUs 515,525,530 and n transmit data packets 590 to the AP 505 concurrently, and, in phase XII, the AP 505 responds with ACKS 595.

As understood by those of skill in the art, the AP 505 and the MUs 510-n may continue communicating over the channel past the phase XII until and/or after a subsequent refresh period. As discussed above, after the subsequent refresh period is initiated, the AP 505 may again broadcast the training packets in the first mode of communication or in the MIMO mode.

Furthermore, those skilled in the art would understand that the present invention provides certain advantages over conventional systems. For example, in a conventional MIMO system, an AP communicates only with a single MU, but at an increased bit rate (e.g., 216 mbps). In contrast, the present invention provides for an AP which communicates with two or more MUs at a lower bit rate (e.g., 54 mbps), allowing for compatibility with legacy 802.11 systems which may not be capable of handling the increased bit rate without significant hardware and software modifications. Furthermore, the present invention provides for increased system throughput with minimized overhead, by allowing the AP to communicate with at least two MUs concurrently, and vice-versa.

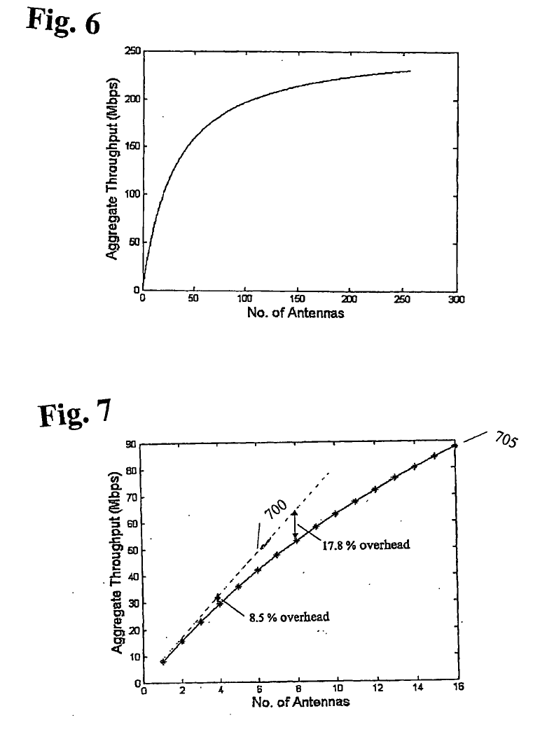

As noted above, the AP and/or the MUs may have two or more antennas and receivers. FIG. 6 shows a graph representing an exemplary relationship between an aggregate throughput and a number of antennas on the AP and the MUs for a system utilizing the present invention. As shown in FIG. 6, the aggregate throughput increases in a hyperbolic manner until a saturation point (e.g., 250 antennas, 225 mbps), in which the channel may not be able to support any further transmissions thereon. FIG. 7 shows a enlarged view of a portion of the graph of FIG. 6. In FIG. 7, a first ray 700 indicates the exemplary relationship of the graph in FIG. 6. A second ray 705 indicates a practical relationship due to anticipated overhead created as a result of the present invention. As the number of antennas is increased, so does the anticipated overhead. However, the anticipated overhead is relatively low considering that, for example, eight MUs may be communicating at the same time and on the same frequency at 54 mbps.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
an access point transmitting a predetermined number of first signals using a first wireless communication mode (“FCM”), the predetermined number of the first signals corresponding to a number of transmitting antennas of the access point, the FCM providing a time slot for each of the first signals to be transmitted; and
a plurality of wireless devices receives each of the first signals, each wireless device utilizes the first signals to generate a first communication matrix;
wherein each of the wireless devices transmits a second signal to the access point,
wherein the access point generates a second communication matrix as a function of the second signals corresponding to a number of selected wireless devices, the number being no greater than the predetermined number,
wherein the access point initiates wireless communications with at least one of the selected wireless devices using a second wireless communication mode (“SCM”), and
wherein, when using the SCM, the access point employs the second communication matrix to resolve multiple wireless communications from the selected wireless devices and each of the selected wireless devices employs the corresponding first communication matrix to resolve multiple wireless communications from the access point during a single time slot over a radio channel.

2. The system of claim 1, wherein each of the first signals includes a first identifier identifying the corresponding transmitting antenna.

3. The system of claim 2, wherein the first communication matrix includes the first identifier from each of the first signals.

4. The system of claim 1, wherein the time slot is obtained by the access point using a carrier sense multiple access (“CSMA”) mechanism.

5. The system of claim 1, wherein the predetermined number of first signals is at least two.

6. The system of claim 1, wherein each of the wireless devices is one of a cell phone, a scanner, a laptop, a network interface card, a PDA and a handheld computer.

7. The system of claim 1, wherein the access point comprises:
a plurality of transmitting antennas;
a plurality of transceivers coupled to the transmitting antennas; and
a processor coupled to the transceivers.

8. The system of claim 1, wherein each of the wireless devices comprises:
a plurality of antennas;
a plurality of receivers coupled to the antennas;
a transmitter coupled to the antennas; and
a processor coupled to the receivers and the transmitter.

9. The system of claim 2, wherein each of the second signals includes a second identifier identifying a corresponding wireless device.

10. The system of claim 9, wherein the first and second identifiers are vectors.

11. The system of claim 1, wherein the access point updates the second communication matrix after one of at least one time slot and a refresh period.

12. The system of claim 1, wherein the FCM utilizes an IEEE 802.11 standard and the SCM utilizes a multiple-in-multiple-out (“MIMO”) mode.

13. A method, comprising:
transmitting, by an access point, a predetermined number of first signals using a first wireless communication mode (“FCM”), the predetermined number of the first signals corresponding to a number of transmitting antennas of the access point, the FCM providing a time slot for each of the first signals to be transmitted;
receiving, by a plurality of wireless devices, each of the first signals, each wireless device utilizes the first signals to generate a first communication matrix;
transmitting, by each of the wireless devices, a second signal to the access point;
generating, by the access point, a second communication matrix as a function of the second signals corresponding to a number of selected wireless devices, the number being no greater than the predetermined number;
initiating, by the access point, wireless communications with at least one of the selected wireless devices using a second wireless communication mode (“SCM”);
when using the SCM, resolving, by the access point, multiple wireless communications from the selected wireless devices in a single time slot over a radio channel using the second communication matrix; and
when using the SCM, resolving, by each of the selected wireless devices, multiple wireless communications from the access point in a further single time slot over the radio channel using the corresponding first communication matrix.

14. The method of claim 13, further comprising:
extracting, by each of the wireless devices, a first identifier from each of the first signals, the first identifier identifying a corresponding transmitting antenna of the access point.

15. The method of claim 14, further comprising:
constructing the first communication matrix with each of the first identifiers.

16. The method of claim 13, wherein the time slot is obtained by the access point using a carrier sense multiple access (“CSMA”) mechanism.

17. The method of claim 13, wherein the predetermined number is at least two.

18. The method of claim 13, further comprising:
extracting, by the access point, a second identifier from each of the second signals, the second identifier identifying a corresponding wireless device.

19. The method of claim 18, further comprising:
constructing the second communication matrix with the second identifier from each of the selected wireless devices.

20. The method of claim 13, wherein each of the wireless devices is one of a cell phone, a scanner, a laptop, a network interface card, a PDA and a handheld computer.

21. The method of claim 13, further comprising:
updating, by the access point, the second communication matrix after one of at least one time slot and a refresh period.

22. The method of claim 13, wherein the FCM utilizes an IEEE 802.11 standard and the SCM utilizes a multiple-in-multiple-out (“MIMO”) mode.
